(19) United States
(12) Patent Application Publication
(10) Pub. No.: US 2022/0147706 A1
(43) Pub. Date: May 12, 2022

(54) OPTIMIZED MACHINE LEARNING MARKETPLACE ASSISTANT

(71) Applicants: USMAN RANA, Orlando, FL (US); Imran Khan, Miami, FL (US)

(72) Inventors: USMAN RANA, Orlando, FL (US); Imran Khan, Miami, FL (US)

(21) Appl. No.: 17/587,732

(22) Filed: Jan. 28, 2022

(51) Int. Cl. G06F 40/205; G06F 40/279; G06F 40/40; G06Q 30/06

(52) U.S. Cl. CPC G06F 40/205; G06Q 30/0641; G06F 40/40; G06F 40/279

(57) ABSTRACT

A method for implementing an automated assistant on one or more computing devices with a processor, a memory, and systems to receive an input at a computing device and parsing that input using a pragmatic natural language processor. A score is assigned to the input and a user intent is determined based on the assigned score. A user may search for a service or item and the system may generate a ranking of the item based on a number of attributes.

### FIELD OF THE INVENTION

This invention relates to a new and improved machine learning marketplace engine.

### BACKGROUND

The world wide web has created the opportunity for consumers to purchase products from the comfort of their homes. There becomes a need for things to happen faster, with more accuracy and better return. Consumers are conscious about price and quality of products and will search for hours and days to find a product of best quality at the most reasonable price. The product may be a car, a phone, an airline ticket, or the like. There are various personal assistant like search engines available in the market today, however, they do not provide the accuracy needed to meet consumer needs.

Today's personal assistant devices and marketplace search engines do not provide exact, accurate, and sorted search results to meet consumer needs. The current platforms are limited in the products that can be searched, found, and purchased. Often, results are generated on these platforms based on paid advertisements and the volume of searches for a particular keyword. What's needed is a single user-friendly device where consumers can search, find, and purchase products of the best quality and price. Consumers will save time, efforts, and money by not having to search a plurality of websites for the one item they desire to purchase. The present invention provides a solution to this problem.

### SUMMARY OF THE INVENTION

It is essential to the present disclosure, all embodiments are provided as illustrative and non-limiting representatives of various possible embodiments. In addition, the terms “is”, “can”, “will” and the like are herein uses as synonyms for an interchangeable with terms such as “may”, “may provide for”, and “it is contemplated that the present invention may” and so forth.

All elements listed by name, encompass all equivalents for such elements. Such equivalents are contemplated for each element named herein.

For purposes of summarizing, certain aspects, advantages, and novel features of the present invention are provided herein. It is to be understood that not all aspects, advantages, or novel features may be provided in any one particular embodiment. Thus, the disclosed subject matter may be embodied or carried out in a manner that achieves or optimizes one aspect, advantages, or novel features or group of features without achieving all aspects, advantages, or novel features as may be taught or suggested.

In view of the foregoing disadvantages inherent in the known art, the present invention provides a novel machine learning search engine. In today's society, consumers can purchase products from the comfort of their homes. There is a need for things to happen faster, with more accuracy and better return. Consumers are conscious about price and quality of products and will search for hours and days to find a product of best quality at the most reasonable price. The product may be a car, a phone, an airline ticket, or the like. There are various personal assistant like search engines available in the market today, however, they do not provide the accuracy needed to meet consumer needs.

Today's personal assistant devices and marketplace search engines do not provide exact, accurate, and sorted search results to meet consumer needs. These platforms are limited in the products that can be searched for and purchased. Results are generated based on paid advertisements and the volume of searches for a particular keyword, and not quality attributes that are important for the consumer. What's needed is a single user-friendly device where consumers can search for and purchase products of the best quality and price. Consumers will save time, effort, and capital by not having to search a plurality of websites for a single item. The present invention provides a solution to this problem.

The features of the invention, which are believed to be novel, are particularly pointed out and distinctly claimed in the concluding portion of the specification. These and other features, aspects, and advantages of the present invention will become better understood with reference to the following drawings and detailed description.

In an embodiment, the present invention provides for a method for implementing a machine learning marketplace automated assistant on one or more computing devices. The method consists of receiving an input at a user device. The input may be a voice input or a text input. The input may for an item, a product, a flight, a service or other similar marketplace component. The system may generate a natural language and contextual processor to parse the input to determine the user intent. A score may be assigned to the input. A trained machine learning model is generated and stored in a system database and a command is determined. The system connects to at least one third party website or database to generate a response to the user.

In a further embodiment, the present invention provides for a machine learning marketplace automated assistant. The device consists of receiving an input at a user device. The input may be a voice input or a text input. The input may for an item, a product, a flight, a service or other similar marketplace component. The system may generate a natural language and contextual processor to parse the input to determine the user intent. A score may be assigned to the input. A trained machine learning model is generated and stored in a system database and a command is determined. The system connects to at least one third party website or database to generate a response to the user.

In another embodiment the present invention provides for a non-transitory computer-readable medium storing programs comprising of systems for a machine learning marketplace automated assistant. The device consists of receiving an input at a user device. The input may be a voice input or a text input. The input may for an item, a product, a flight, a service or other similar marketplace component. The system may generate a natural language and contextual processor to parse the input to determine the user intent. A score may be assigned to the input. A trained machine learning model is generated and stored in a system database and a command is determined. The system connects to at least one third party website or database to generate a response to the user.

The embodiment of the invention described herein are exemplary and numerous modifications, variations, and rearrangements can be readily envisioned to achieve substantially equivalent results, all of which are intended to be embraced within the spirit and scope of the invention. Furthermore, while the preferred embodiment of the invention has been described in terms of the components and configurations, it is understood that the invention is not limited to those specific dimensions or configurations but is to be accorded the full breadth of the spirit of the invention.

### BRIEF DESCRIPTION OF THE DRAWINGS

These and other features, aspects and advantages of the present invention will become better understood with regard to the following description, appended claims, and accompanying figures.

FIG. 1 shows the network connections between the devices in the environment, which are capable of implementing the present embodiments.

FIG. 2 is an exemplary illustrative network environment where various embodiments of the present invention are said to function.

FIG. 3 shows the interior components of the network environment connecting of the devices of the present invention.

FIG. 4 shows the network environment of the machine learning unit.

FIG. 5 shows an exemplary embodiment of the user interface.

FIG. 6 is an exemplary flow chart of the present embodiments.

FIG. 7 is an exemplary flow chart of the present embodiments.

FIG. 8 is an illustrative model of the components of the present invention.

### DETAILED DESCRIPTION

The present invention overcomes the limitations of the prior art by providing a novel machine learning search engine.

It is essential to understand that the drawings and the associated descriptions are provided to illustrate potential embodiments of the invention and not to limit the scope of the invention. Reference in the specification to “one embodiment” or “an embodiment” is intended to indicate that a particular feature, structure, or characteristics described in connection with the embodiment is included in at least an embodiment of the invention. The appearances of the phrases “in one embodiment” or “an embodiment” in various places in the specification are not necessarily all referring to the same embodiment.

As used in this disclosure, except where the context requires otherwise, the term “comprise” and various of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may be shown in detail in order not to obscure the embodiments.

The system of the present invention is suitable for novel machine learning search engine.

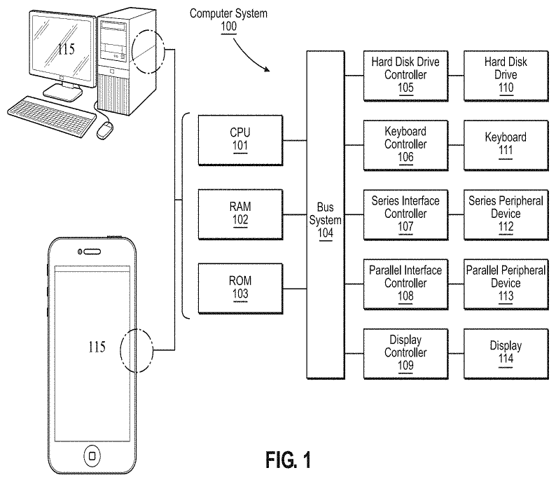

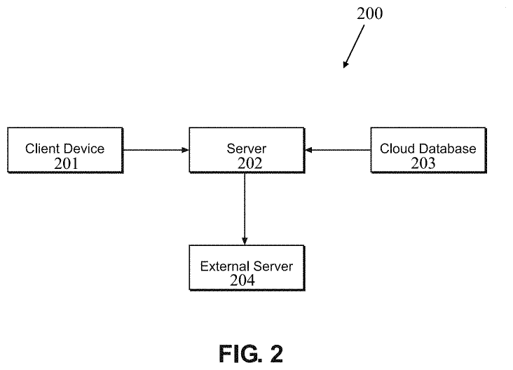

FIG. 1 shows the network connections between the devices in the environment, which are capable of implementing the present embodiments. Computing device 115 can be of a portable device or a non-portable device. Client device 115 may be a handheld device, a mobile device, smartphone, personal digital assistant (PDA), a personal computer, netbook, laptop, a tablet, a smartwatch, a car module, or similar computer system device equipped with a wireless transceiver providing the communication interface. The client device may comprise of a central processing unit 101, a random-access memory 102, a read only memory 103, at least one bus 104, a plurality of controllers 105-109, a plurality of ports, such as a USB port, a data storage devices 110, such as a hard disk drive or a flash memory, a keyboard 111, a series and parallel peripheral device 112-113, and a display 114. Client devices may comprise of an operating module working conjointly with the processor to execute a plurality of machine learning algorithms, the data and models of which are stored in memory. Client device 115 may further be of an audio interface, a video interface, a network interface, an input-output interface, and at least one display. Client device 115 may be connected to at least one Server 202 as displayed in FIG. 2. The software application may comprise of at least one security feature. A user may connect to the application using face recognition, password input, or other biometrical authentication method. Turning attention to FIG. 2.

The embodiments may further exist as a gaming device. A user of the device may have the ability to interact with other users of the application. A user may create an animated feature that may interact with other platform users, the avatar from one user device may appear to jump from a first user device to another user device to deliver a message or perform an action. Users may interact by sharing at least one gift or sharing a file. A gift may comprise of a hug, a wakeup call, a reminder, and the like. The platform may allow for financial transactions within the embodiments, where users may transfer and process funds, such as cryptocurrency, between devices. Users of the application may interact in a group setting. A user may send a request to another user to interact within a group setting or delete a user from a group. Each device may have a unique identifier that may be used to connect users of a plurality of devices.

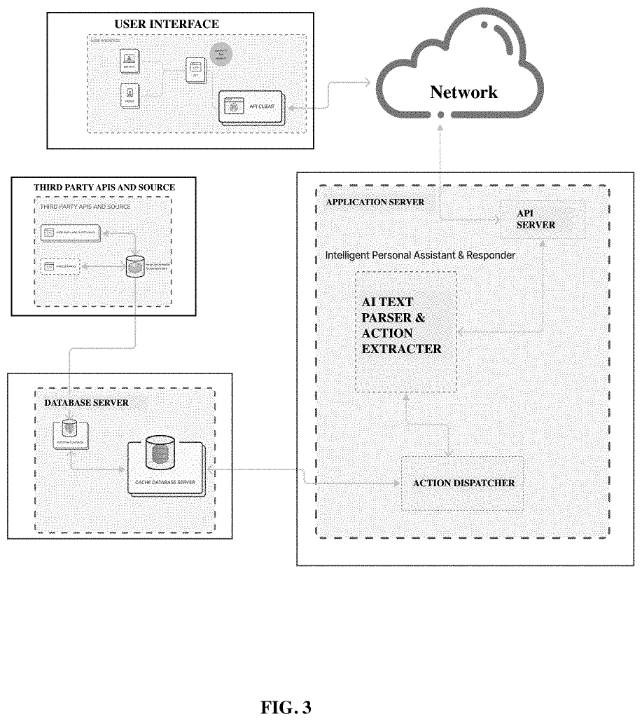

FIG. 2 is an exemplary illustrative network environment where various embodiments of the present invention are said to function. Client device 201 may be connected to at least one Server 202. Server 202 may be connected to at least one external server 204 and a central Database 203. Database 203 may comprise of a cloud-based server and may further include at least one archived database. Server 202 is configured to receive and transmit information between the client device 201 and Database 203. Server 202 may comprise of system to run server applications, to maintain the databases, and a network to connect devices to the internet. The network may comprise of a communication interface. The external server may comprise of a marketplace with purchasable items. Turning attention to FIG. 3.

FIG. 3 shows the interior components of the network environment connection of the devices of the present invention. At least one user interface 301 may connect to the network 302. The network 302 may connect the user interface 301 to the application server 303 of the present invention. The application server 303 may comprise of a plurality of components. For example, the application server 303 may comprise of at least one server, an artificial intelligence text parser and action extractor, and an action dispatcher. The artificial intelligence text parser may comprise of systems to receive a set of user voice or text inputs, parse the inputs, determine the intent and entity from the user input, create and update a trained model, and generate a response to the user. The response may be displayed in a plurality of languages, currency values, based on the user's preferences.

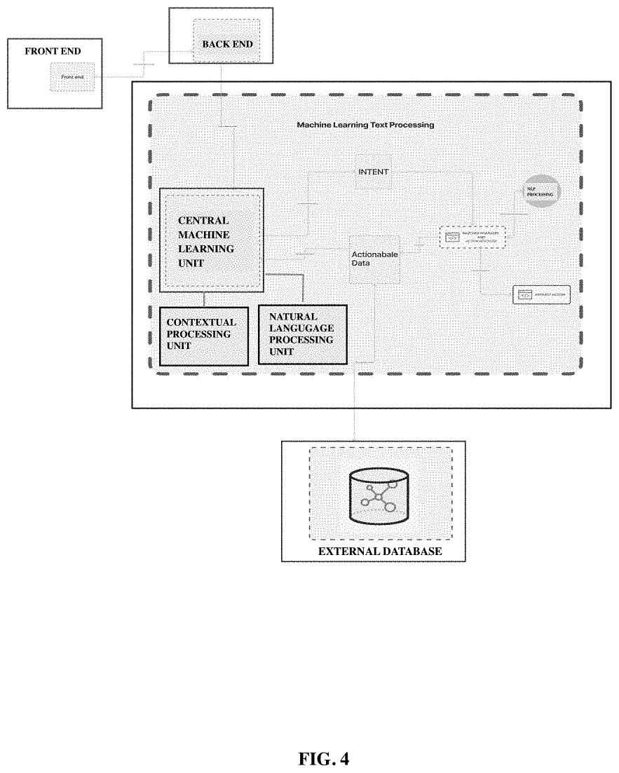

The application server 303 may further communicatively couple to at least one server database 304. The server database 304 may serve as a storage component for user inputs, trained machine learning models, and archived inputs. The server database 304 may communicatively couple to a plurality of external devices, such as a third-party application interfaces and sources 305. The external device 305 may be used to retrieve customer reviews, search histories, prices, and other pertinent data related to a user's search. The application interface may communicatively couple to other websites to bring the searched item or service into one platform. Users will save time by not having to search multiple websites for an item or service. The present invention may act as a personal assistant to communicatively couple to other websites to read through product descriptions and allocate the user with the best matched product for their search. The best matched item may be based on a plurality of indicators such as but not limited to customer reviews, search histories, and prices. Thus, producing more cost-effective and time-consuming results for the user. Turning attention to FIG. 4.

FIG. 4 shows the network environment of the machine learning unit 400. A front-end server 401 may communicatively couple to a back-end server 402. The back-end server 402 may communicatively couple to the machine learning text processing unit 403. The machine learning text processing unit 403 may comprise of at least one central machine learning unit 404. The machine learning text processing unit 403 may communicatively couple to at least one external database 405. The machine learning text processing unit 403 may comprise of a natural language processing unit 406 and a contextual text processing unit 407.

The natural language processing unit 406 comprise of systems to perform one or more lexical or dependency parsing analysis. Specifically, the natural language processing unit 406 may perform a pragmatic analysis. However, the systems may also perform various other lexical analysis such as a semantic analysis, syntactical analysis, or other types of analytic directed to understanding textual content. With pragmatic analysis, the natural language processing unit 406 may determine the actual meaning and intent of the user. The user input may be a voice or text input. In generating the analysis, the natural language processing unit 406 may identify the intent of the user. The contextual text processing unit 403 may further be used to identify the intent of the user. The contextual analysis may be performed prior to or after the natural language processing. The contextual analysis may be introduced to the processed pragmatic analysis.

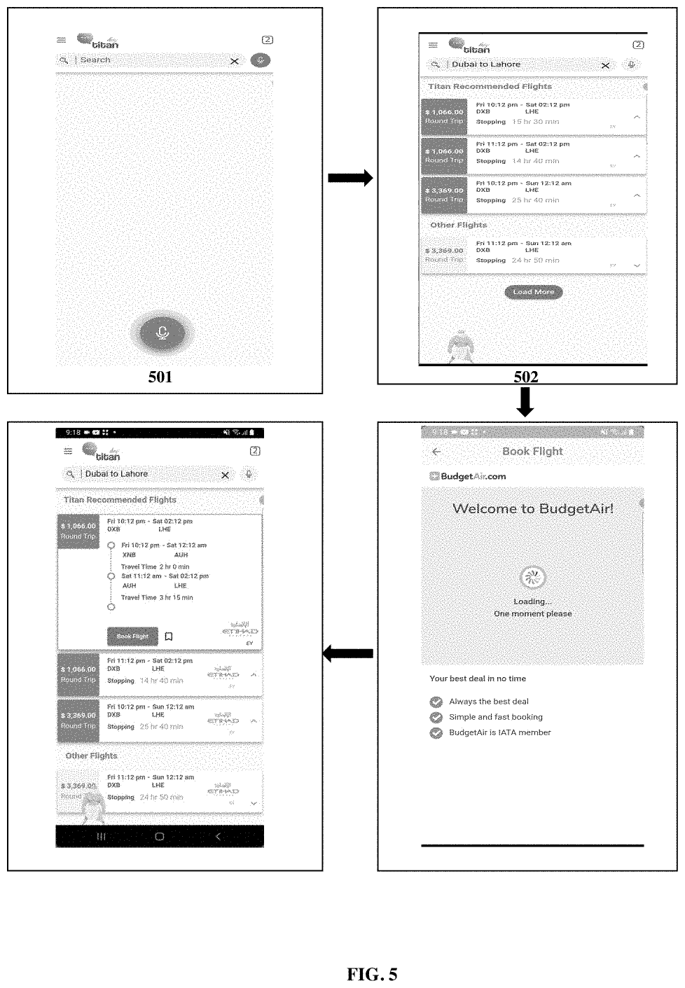

The system may learn from a user's historical selections and searches, and may generate responses based on a learned behavior of the user. The embodiments may recommend products for purchase by the user, the recommendation may be based on a user's historical selections. For example, the system may generate a notification to the user, based on historical data, to purchase at least one item. The item may be for a vacation, a health product, a clothing product, a food product, or the like. Turning attention to FIG. 5.

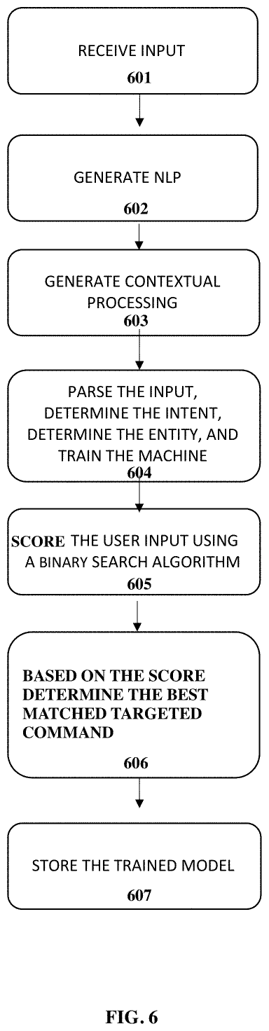

FIG. 5 shows an exemplary embodiment of the user interface 500. At interface 501 the device may receive at least one user input. The user input may comprise of a voice input, a text input, or both. For example, a user may ask the personal assistant to search for a flight to a particular destination and at a particular time. As a response, the system may generate at least one response to the user as shown in interface 502. For example, the response may comprise of the top three options for the user. The top options may comprise of the most reasonably priced flights at the most appropriate time for the user. The list may generate on the user device without redirecting the user to a third-party portal. At interface 503, a listed item may be expanded to reveal further details on the transaction. At interface 504, the user may purchase the item. While the example shows the purchase of an airline ticket. The system 500 may be used to purchase any item, for example, an apparel, or other wearable device. The novelty of the present invention is that a user may purchase any item from one application interface. A user saves time and effort from having to search various third-party platforms for the various items. The machine learning system finds and recommends the best matched item for the user. The best matched item may be determined by a scoring model. Turning attention to FIG. 6.

FIG. 6 is an exemplary flow chart of the present embodiments. To generate user responses and for the proper functioning of the application interface, the system first trains the machine learning model. At step 601 the device receives a plurality of user inputs. The user input may comprise of voice inputs or text inputs. At step 602, the system generates the natural language processing unit. The natural language processing unit may perform one or more lexical or dependency parsing analysis. Specifically, the natural language processing unit may perform a pragmatic analysis. However, the systems may also perform various other lexical analysis such as a semantic analysis, syntactical analysis, or other types of analytic directed to understanding textual content.

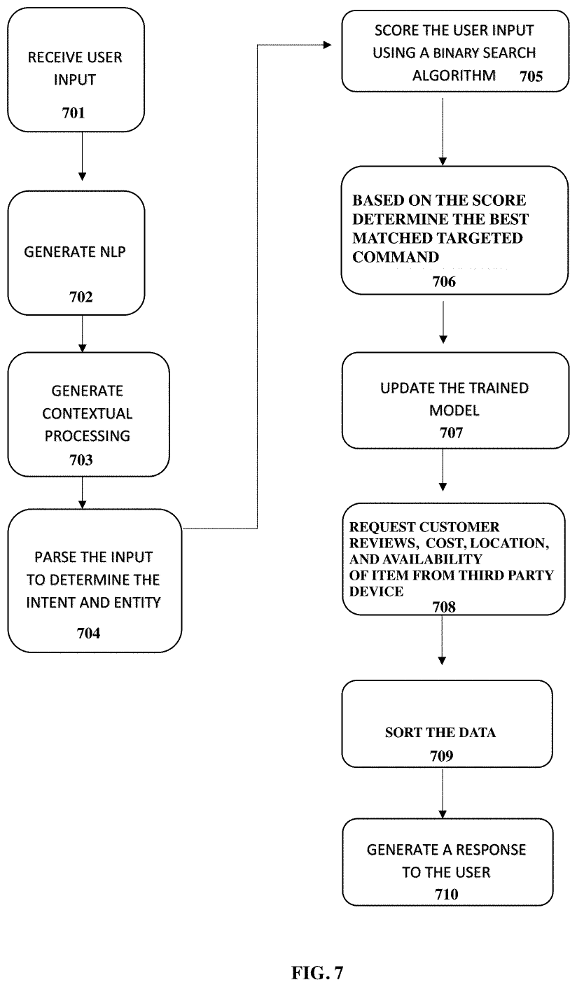

With pragmatic analysis, the natural language processing unit may determine the actual meaning and intent of the user. A user intent and entity may be determined. At step 603 the system generates the contextual processing unit. The contextual analysis may be introduced to the processed pragmatic analysis. The contextual text processing unit may be used to identify the intent of the user. The contextual analysis may be performed prior to or after the natural language processing. At step 604 the device may parse the input to determine an intent and entity in the input to train and create a machine learning model. At step 605 the system may score the user input using a binary search algorithm. At step 606, the system may score the user input based on the search history of the key terms, customer reviews, cost of the item, location, and availability of the item. At step 607, the system may store the trained model in a user database. Turning attention to FIG. 7.

FIG. 7 is an exemplary flow chart of the present embodiments. At step 701 the device receives a plurality of user inputs. The user input may comprise of voice inputs or text inputs. At step 702, the system generates the natural language processing unit. The natural language processing unit may perform one or more lexical or dependency parsing analysis. Specifically, the natural language processing unit may perform a pragmatic analysis. However, the systems may also perform various other lexical analysis such as a semantic analysis, syntactical analysis, or other types of analytic directed to understanding textual content. With pragmatic analysis, the natural language processing unit may determine the actual meaning and intent of the user. A user intent and entity may be determined. At step 703 the system generates the contextual processing unit. The contextual analysis may be introduced to the processed pragmatic analysis. The contextual text processing unit may be used to identify the intent of the user. The contextual analysis may be performed prior to or after the natural language processing. At step 704 the device may parse the input to determine an intent and entity in the input to train and create a machine learning model. At step 705 the system may score the user input using a binary search algorithm. At step 706, based on the score the server may determine the best matched targeted command. At step 707, the server may update the trained model and store it in the database. At step 708, a plurality of data may be requested by the device from third party external devices. For example, the device may request reviews, cost, location, and availability of the item from third party servers. Upon receipt, as shown in Step 709, the server will filter, sort, and rank the data based on a plurality of attributes, such as availability, quality, and price. At step 710, the server may generate a response to the user and display the response in the user interface. The requested information may be received and sorted by the device

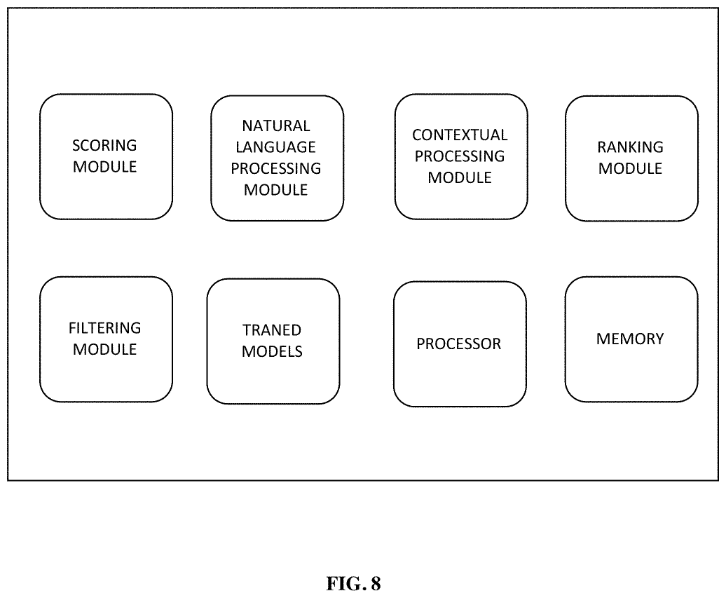

FIG. 8 is an illustrative model of the components of the present invention. The present invention may comprise of a scoring module 801, a natural processing module 802, a contextual processing module 803, a ranking module 804, a filtering module 805, a trained models database 806, at least one processor 806, and at least one memory. The scoring module 801 may comprise of systems to generate a score to each user input using a binary search algorithm. A best matched targeted command is determined based on the score assigned to the parsed input. The natural language processing module 802 may perform one or more lexical or dependency parsing analysis. Specifically, the natural language processing unit may perform a pragmatic analysis. The contextual processing module 803 may be introduced to the processed pragmatic analysis to identify the intent of the user. The ranking module 804 may rank the data received from a third-party server to determine the order of listing of items on the user interface. The filtering module 805 may receive the third-party server response and filter through the responses. The filtration method may be based on a plurality of attributes defined by industry and category. The received input will be processed and parsed to determine the user's intent. A command will be generated based on the determined intent. The trained model's database 806 may store a plurality of trained models. These machine learning models may be used to recognize user inputs and quickly generate and predict responses. The machine learning system may comprise of a supervised regression model. However, the systems may be set to provide for unsupervised learning. The regression model may comprise of a linear regression, decision trees, random forest, neural networks, or the like.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in the disclosure.

All features disclosed in the specification, including the claims, abstracts, and drawings, and all steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or some similar purpose, unless expressly stated otherwise. Thus, unless expressly stated otherwise, each feature disclosed is one example only of a generic series of equivalent or similar features.

While the present invention generally described herein has been disclosed in connection with a number of embodiments shown and described in detail, various modifications should be readily apparent to those of skill in the art.

What is claimed is:

1. A method for implementing a machine learning marketplace automated assistant on one or more computing devices comprising of one or more processors or memory, the method comprising, training a machine learning model to:
receive a marketplace input at a computing device;
generate natural language processing of the marketplace input;
generate contextual processing of the marketplace input;
parsing the input using the natural language processor;
parsing the input using the contextual processor;
determine the intent and entity of the marketplace input;
assign a score to the marketplace input;
generate a machine learning model;
determine the best matched command based on the score;
storing the trained machine learning model;
request a plurality of attributes from a third-party website;
generate a response to the user.

2. The method of claim 1, wherein the marketplace input is at least one item.

3. The method of claim 1, wherein the marketplace input is at least one service.

4. The method of claim 1, wherein the score is generated using a binary search algorithm.

5. The method of claim 1, wherein the trained model is automatically updated.

6. The method of claim 1, wherein the natural language processor performs a pragmatic analysis of the input.

7. The method of claim 1, wherein the attribute comprises of at least one of a customer review, a price, a search history, a quality, a quantity, and an availability of an item.

8. The method of claim 1, further comprising: requesting data from a third-party database.

9. The method of claim 2, wherein the at least one item is a clothing item.

10. The method of claim 2, wherein the at least one item is a flight item.

11. A machine learning marketplace automated assistant operating on one of more computing device comprising of a plurality of processors, a memory, an input and output component to:
receive a marketplace input at a computing device;
generate natural language processing of the marketplace input;
generate contextual processing of the marketplace input;
parse the input using the natural language processor;
parse the input using the contextual processor;
determine the intent and entity of the marketplace input;
assign a score to the marketplace input;
generate a trained model;
determine the best response based on the score;
store the trained model;
request a plurality of attributes from a third-party website;
generate a response to the user.

12. The machine learning marketplace automated assistant of claim 1, wherein the marketplace input is at least one of a clothing item, a service item, or flight item.

13. The machine learning marketplace automated assistant of claim 1, wherein the score is generated using a binary search algorithm.

14. The machine learning marketplace automated assistant of claim 1, wherein the natural language processor performs a pragmatic analysis of the marketplace input.

15. The machine learning marketplace automated assistant of claim 1, wherein the attribute comprises of at least one of a customer review, a price, a search history, a quality, a quantity, and an availability of an item.

16. The machine learning marketplace automated assistant of claim 1, further comprising: requesting data from a third-party database.

17. A non-transitory computer-readable medium storing program comprising of a machine learning marketplace automated assistant, that causes a processor to:
receive a marketplace input at a computing device;
generate natural language processing of the marketplace input;
generate contextual processing of the marketplace input;
parse the input using the natural language processor;
parse the input using the contextual processor;
determine the intent and entity of the marketplace input;
assign a score to the marketplace input;
generate a trained model;
determine the best response based on the score;
store the trained model;
request a plurality of attributes from a third-party website;
generate a response to the user.

18. The apparatus of claim 1, wherein the marketplace input is at least one of a clothing item, a service item, or flight item.

19. The apparatus of claim 1, wherein the score is generated using a binary search algorithm.

20. The apparatus of claim 1, wherein the natural language processor performs a pragmatic analysis of the input; wherein the attribute comprises of at least one of a customer review, a price, a search history, a quality, a quantity, and an availability of an item.
